(19) United States
(12) Patent Application Publication
(10) Pub. No.: US 2003/0069982 A1
(43) Pub. Date: Apr. 10, 2003

(54) Method and system for generating privacy-specified internet session content records in a communications network

(76) Inventors: Colby Harper, Seattle, WA (US); Doborah D. Harper, Seattle, WA (US)

Correspondence Address: Colby Harper, Suite 100, 2402 E. Newton Street, Seattle, WA, 98112, US

(21) Appl. No.: 10/189,726

(22) Filed: Jul. 3, 2002

Related U.S. Application Data
(60) Provisional application No. 60/302,374, filed on Jul. 3, 2001.

(51) Int. Cl. G06F 15/16

(52) U.S. Cl. 709/228

(57) ABSTRACT

A method and system for generating privacy-specified Internet session content records (8) in a communications network is disclosed which enables a communications service provider—through subsequent differential access authorization treatment to a customer's session content record (SCR)(3D, 2C, 3E) payload as specified in the customer privacy detail portion of the record (6B, 6C & 7B, 7C)—to provide their customers stronger and more flexibly specified privacy protection regarding the disclosure of their customers' customer-proprietary communications session content information and customer-proprietary network information—that is, the SCR (3D, 2C, 3E), than previously possible. This invention relates to monitoring, capturing, and the subsequent handling of data transported over a communications network and communications network events related to that data.

This application claims priority of Provisional Application No. 60/302374 filed on July 3^{rd} of the year 2001.

### BACKGROUND—FIELD OF INVENTION

This invention relates to monitoring, capturing, and the subsequent handling of data transported over a communications network and communications network events related to that data.

A method and system for generating privacy-specified Internet session content records in a communications network is disclosed.

### BACKGROUND—DESCRIPTION OF PRIOR ART

Communications network service providers such as Internet service providers and local and long-distance telephony and data network service providers commonly monitor their customer's communication sessions and generate descriptive records detailing each communication session. These records commonly serve as measurement units and reference items for which to bill customers for use of the communications services.

Such descriptive records are also transferred to other systems used by other organizations internal and external to the provider for purposes including but not limited to target-marketing, fraud-management, law-enforcement surveillance, forensics and evidentiary processes, and communications network performance and capacity planning. Management of access to this substantially proprietary-to-the-customer network usage information commonly was and is via separate human-workflow-oriented business processes without significant integration into the monitoring and descriptive record generating systems themselves. This lack of integration provided a particularly weak linkage between these monitoring systems and their commonly associated privacy protection and management processes.

These records originally detailed only basic attributes of each actual communication session (such as in a telephone call voice-session specifying calling and called party telephone numbers and session time and duration; such record is commonly referred to as a “CDR” or “Call Detail Record” or, alternatively, an “SDR” or “Session Detail Record” of voice type). However, as types of sessions (such as email and information download sessions) proliferated due to the flexibility of Internet Protocol-based services, service providers and customers objected to the then common billing measurement units (such as the number of minutes duration of a session) as an inflexible and inaccurate description of the actual consumption-behavior during sessions which customers used the newer types of communications network services and associated resources.

Thereafter, the problem of inaccuracy was partially addressed by subsequent implementation of larger numbers and types of descriptive attributes provided in each SDR. Inventors created several methods of monitoring and detailing more and alternative attributes for measuring and billing (and analyzing) customers for each actual communications session (such as total kilobytes transferred during an information download session). However, the privacy-sensitivity of these newer, more information-rich SDR's increased relative to the older “CDR-style” records due to the increased and varied information they contained.

Although providing more and varied descriptions of the customer communications sessions, these tracking methods generated only descriptions of the communication sessions (Session *Description* Records); they were not a high-fidelity, reasonable facsimile of the communication sessions themselves as they lacked the actual content of the Internet Protocol-based communications session itself. Accordingly, business processes such as non-repudiation for billing and law-enforcement surveillance commonly operated and operate impaired on a non-deterministic, “best-guess” basis because a descriptive record of a thing is not a facsimile of the thing itself. That is, the recorded “measurement” is not the same as “the thing or event measured” and any descriptions derived from the recorded measurements are even less substantially substitutable for the measured thing or event itself (which is, in this case, the customer's communication session).

Capturing the actual content of communications sessions, even as it is occuring in real-time, is a capability increasingly available to communications service providers. However, due to reasons including but not limited to the relative newness and lack of awareness of methods to capture the actual Internet Protocol-based communications session content at all, the application of this capability is commonly aimed at occasional inspections rather than ongoing monitoring and billing record generation operations; the Session Description Records commonly remained nonintegrated with their respective communication sessions' captured content itself. Further, service providers and customers increasingly demand that ongoing monitoring and billing record generation processes and associated systems operate in real-time (as a means to enable such capabilities as pre-paid billing and proactive quality-of-service management). The noted lack of awareness of content capture capability is even more acute with regards to real-time Internet communications session content capture.

Capturing a communication session's content is necessary but not sufficient to create a Session Content “Record” or “SCR.” Session monitoring, measuring, and detailed description applied while capturing a session and embedding a copy within its associated detailed description allows the creation of a Session *Content* Record (S *C* R rather than an S *D* R).

However—as with the increasingly information-rich Session Description Records—Session Content Records (SCR's) too will increase the need for their privacy protection and management still further, as an SCR as specified here includes both the record of descriptive detail of the original customer communications session and an embedded copy of the communications session content itself.

Particularly with such a high-fidelity record as a Session Content Record, customers not only object to communications service providers lack of strong privacy-protection for such records during their generation and subsequent handling, transfer, and temporary and archival storage, but also object to the lack of a mechanism allowing the customer themselves flexible input into the information sharing policy specification regarding their own such records.

### OBJECTS AND ADVANTAGES

Accordingly, several objects and advantages of my invention are:

(a) to provide a communications session record generation method which enables both increased-fidelity records and increased privacy protection;

(b) to provide a communications session record generation method which allows for a significant and convenient integration of privacy protection and management of access to customer-proprietary network usage description and content information into the monitoring and record generating and handling systems;

(c) to provide a communications session record generation method which enables complete, self-contained records with privacy-protection inherent in the composition of the record itself;

(d) to provide a communications session record generation method which enables the significant reduction of privacy holes in subsequent record processing systems and handling;

(e) to provide a communications session record generation method which enables stronger privacy-protection and management because it is a session content record and as such throughout its lifecycle keeps the session content and session description record information combined in a self-contained and therefore—relative to separate and dispersed session content and session description information—a more easily tracked, managed, and auditable unit;

(f) to provide a communications session record generation method which enables still stronger privacy-protection and management because it is a privacy-specified session content record and as such throughout its lifecycle keeps the aforementioned session content record and customer-specified privacy policy information combined in a self-contained and therefore—relative to separate and dispersed privacy policy and session content record information—a more easily tracked, managed, auditable, and protectable unit;

(g) to provide a communications session record generation method which allows real-time customer-determined, flexible privacy specification for session content records at the point of record origination and the substantial strengthening of the chain-of-custody of such privacy-sensitive records;

(h) to provide a communications session record generation method which enables Session Description Records (SDR's) to be enriched with the session content itself embedded in the detailed description record (SDR) of that content, resulting in a Session Content Record (SCR) therefore providing a more reasonable facsimile of the actual communications session and enabling more deterministic and thorough non-repudiation, surveillance, forensics, and evidentiary processes; and

(i) to provide a communications session record generation method which enables communications service providers to provide strong privacy-protection for records during their generation and subsequent handling, transfer, and temporary and archival storage, particularly with such high-fidelity records as Session Content Records—where privacy-sensitivity is especially high—while also providing customers a mechanism for customer input into the information sharing policy specification regarding their own such records.

Further objects and advantages of my invention will become apparent from a consideration of the drawings and ensuing description.

### DRAWING FIGURES

The drawing figures depict the present invention by way of example, not by way of limitations.

In the figures, like reference numerals refer to the same or similar elements.

FIG. 1 is a diagrammatic illustration of a plurality of original content fragments from a customer internet session (1A-E) showing its relation to an aggregation of content of said customer internet session (2A) (eg: Voice Over IP Call), and to a record of descriptive detail of said customer internet session (SDR)(3A)(eg: Calling and Called Party IP Address, Time of Day, Location of Parties) according to one embodiment of the invention.

FIG. 2 shows a simplified block diagram of a record (‘SCR”)(4) associated with said original customer internet session based on said record of descriptive detail of said original customer internet session (3A) (ie: the ‘SDR’), wherein the record (4) also contains said session content itself (2B), embedded within the SDR (3B & 3C), which has been constructed pursuant to one preferred embodiment of the invention.

FIG. 3 shows a simplified block diagram of a record (ie: ‘Customer Privacy Detail Record’ or ‘CPDR’) (5) associated with said original customer, storing data indicating said customer's preferences regarding Opt-IN access authorization to said customer's proprietary information (6A) and data indicating what specific proprietary information is authorized for access by whom (7A), according to one embodiment of the invention.

FIG. 4 shows a simplified block diagram of a record (ie: ‘Privacy-Specified Session Content Record’ or ‘PS-SCR’) associated with said original customer internet session based on said CPDR (5), wherein the record also contains said associated SCR (3D, 2C, 3E), embedded within the CPDR (6B, 6C & 7B, 7C), which has been constructed pursuant to one preferred embodiment of the invention.

### REFERENCE NUMERALS IN DRAWINGS

1 customer session content fragment

2 customer session content

3 customer session description record

4 customer session content record

5 customer privacy detail record

6 customer's opt-in information for authorization for sharing of customer-proprietary content and network information

7 customer's information for specification of what customer-proprietary content and network information can be shared and with whom it can be shared

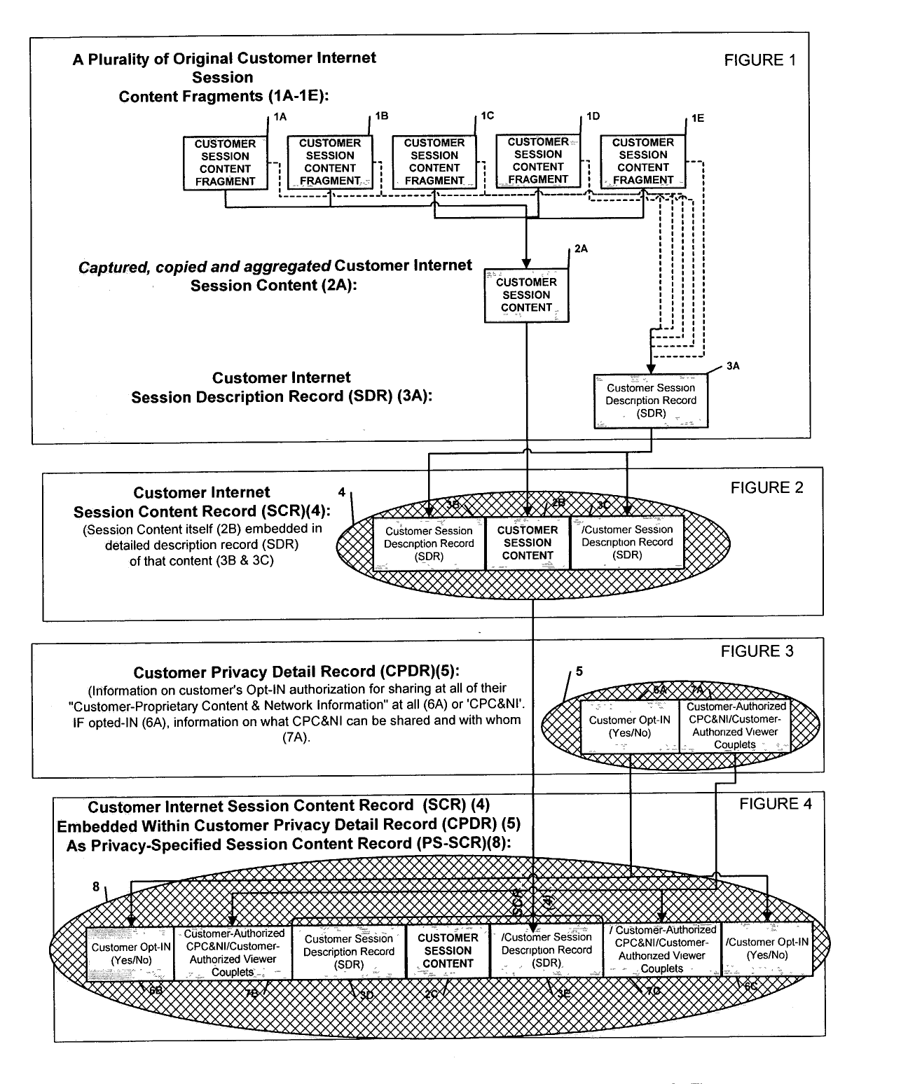

8 privacy-specified session content record ps Description—Main Embodiment, FIGS. 1 to 4

A method and system for generating privacy-specified Internet session content records in a communications network is disclosed.

FIG. 1 is a diagrammatic illustration of a plurality of original content fragments from a customer internet session (1A-E) showing its relation to an aggregation of content of said customer internet session (2A) (eg: Voice Over IP Call), and to a record of descriptive detail of said customer internet session (SDR)(3A)(eg: Calling and Called Party IP Address, Time of Day, Location of Parties) according to one embodiment of the invention.

FIG. 2 shows a simplified block diagram of a record (‘SCR”)(4) associated with said original customer internet session based on said record of descriptive detail of said original customer internet session (3A) (ie: the ‘SDR’), wherein the record (4) also contains said session content itself (2B), embedded within the SDR (3B & 3C), which has been constructed pursuant to one preferred embodiment of the invention.

FIG. 3 shows a simplified block diagram of a record (ie: ‘Customer Privacy Detail Record’ or ‘CPDR’) (5) associated with said original customer, storing data indicating said customer's preferences regarding Opt-IN access authorization to said customer's proprietary information (6A) and data indicating what specific proprietary information is authorized for access by whom (7A), according to one embodiment of the invention.

FIG. 4 shows a simplified block diagram of a record (ie: ‘Privacy-Specified Session Content Record’ or ‘PS-SCR’) associated with said original customer internet session based on said CPDR (5), wherein the record also contains said associated SCR (3D, 2C, 3E), embedded within the CPDR (6B, 6C & 7B, 7C), which has been constructed pursuant to one preferred embodiment of the invention.

Operation—Main Embodiment, FIGS. 1 to 4

In one embodiment of the invention, the generation of privacy-specified Internet session content records (8) enables a communications service provider—through subsequent differential access authorization treatment to the session content record (SCR) (3D, 2C, 3E) payload as specified in the CPDR portion of the record (6B, 6C & 7B, 7C)—to provide to their customers stronger and more flexibly-specified privacy protection regarding the disclosure of their customers' customer-proprietary communication-session content information and customer-proprietary network information (ie: the SCR) (3D, 2C, 3E)than previously possible.

In one embodiment of the invention, a method of generating privacy-specified internet session content records (8) in a communications network is disclosed, comprising the steps of:

(a) non-intrusively monitoring a communications network for all content fragments (FIG. 1) (1A-1E) and descriptive network events associated with a given customer's communication session,

(b) non-intrusively capturing and copying all of said content fragments (1A-1E) into a store of aggregated session content (2A) (FIG. 1),

(c) non-intrusively capturing all of said descriptive network events into a session description record (SDR)(3A) (FIG. 1),

(d) combining said session description record (3A) and said session content (2A) into a single session record (4) to generate a complete, self-describing, session content record (SCR)(4) for said original customer internet session (FIG. 2),

(e) said customer configuring a privacy preference (Customer Privacy Detail Record, ‘CPDR’) (5) profile regarding their customer proprietary content information and customer proprietary network information and who may access said information (FIG. 3),

(f) a CPDR application generating a CPDR (5) based on said customer's said CPDR profile (FIG. 3). Said CPDR (5) containing said customer's preferences regarding Opt-IN access authorization to said customer's proprietary information (6A) and at least one CPDR couplet, indicating what specific proprietary information is authorized for access by whom (7A). A given CPDR couplet (7A) comprising the information within the CPDR (5) specifying a single WHAT/WHO data pair: (Eg: “ALLOW <My Location> / <My Favorite Gas Station Chain>” or “ALLOW <My Voice Session Content> / <LAWFULLY AUTHORIZED>; DENY <My Voice Session Content> / <ALL OTHERS>” or “ALLOW <My IP Address> / <My Favorite Online Department Store>”).

(g) further combining said customer privacy detail record (CPDR)(5) and said session content record (SCR)(4) into a single record to generate a complete, privacy-specified session content record (PS-SCR) (8) for said original customer internet session (FIG. 4).

Description and Operation—Alternative Embodiments

In an alternative embodiment, the system and method simultaneously monitor both real-time session content records (SCR's) for a given customer communications session and real-time changes in customer privacy data records (CPDR's), gather information about customer session and privacy preferences from both sources, combine said gathered information into a privacy-specified session content record (PS-SCR), gather real-time privacy preference information updates from said CPDR-source, and dynamically re-specify the privacy preferences for said PS-SCR of said customer's session.

Summary, Ramifications, and Scope

Accordingly, the reader will see that the method's privacy-specification and combination with the session content record of this invention can be used to simultaneously increase both the record's fidelity to the original communications session and the strength and flexibility of protection communications service providers can provide to their customers regarding the disclosure of their customers' customer-proprietary communications session content information and customer-proprietary network information—that is, the SCR (Session Content Record).

Furthermore, the method's self-contained nature of the combined privacy-specification and session content record method have the additional advantages in that:

it allows for a significant and convenient integration of privacy protection and management of access to customer-proprietary network usage description and content information into the monitoring and descriptive record generating and handling systems;

it allows self-contained records with privacy-protection inherent in the composition of the record itself;

it enables the significant reduction of privacy holes in subsequent record processing systems and handling;

it enables stronger privacy-protection and management because it is a session content record and as such throughout its lifecycle keeps the session content and session description record information combined in a self-contained and therefore—relative to separate and dispersed session content and session description information—a more easily tracked, managed, and auditable unit;

it enables still stronger privacy-protection and management because it is a privacy-specified session content record and as such throughout its lifecycle keeps the session content record and customer-specified privacy policy information combined in a self-contained and therefore—relative to separate and dispersed privacy policy and session content record information—a more easily tracked, managed, auditable, and protectable unit;

it allows real-time customer-determined, flexible privacy specification for session content records at the point of record origination and the substantial strengthening of the chain-of-custody of such privacy-sensitive records;

it enables Session Description Records (SDR's) to be enriched with the session content itself embedded in the detailed description record (SDR) of that content, resulting in a Session Content Record (SCR) therefore providing a more reasonable facsimile of the actual communications session and enabling more deterministic and thorough non-repudiation, surveillance, forensics, and evidentiary processes; and

it enables communications service providers to provide strong privacy-protection for records during their generation and subsequent handling, transfer, and temporary and archival storage, particularly with such high-fidelity record as Session Content Records—where privacy-sensitivity is especially high—while also providing customers a mechanism for customer input into the information sharing policy specification regarding their own such records.

Although the description above contains many specificities, these should not be construed as limiting the scope of the invention but as merely providing illustrations of some of the presently preferred embodiments of this invention. For example, the Privacy-Specified Session Content Record can have subsequent additional handling steps, such as encryption, etc.

Thus the scope of the invention should be determined by the appended claims and their legal equivalents, rather than by the examples given.

I claim:

1. A method for generating privacy-specified Internet session content records in a communications network, comprising the steps of:
(a) non-intrusively monitoring a communications network for all content fragments and descriptive network events associated with a communications session, and
(b) non-intrusively capturing and copying all of said content fragments into a store of aggregated session content, and
(c) non-intrusively capturing and copying all of said descriptive network events into a session description record, and
(d) combining said session description record and said store of aggregated session content into a single session record to generate a session content record for said communications session, and
(e) configuring a privacy preference profile regarding proprietary content information and proprietary network information and who may access said content and network information, and
(f) generating a privacy preference detail record from said privacy preference profile, said privacy preference detail record containing the privacy preferences regarding access authorization to said content and network information, and
(g) further combining said privacy preference detail record and said session content record
whereby a single privacy-specified session content record is generated for said communications session.

2. The method of claim 1, wherein said communications session is an Internet Protocol-based communications session.

3. A system for generating Internet session records in a communications network, characterized in that the records are comprised of communications session content, associated communications session description, and associated specified privacy authorization information, comprising the steps of:
(a) non-intrusively monitoring a communications network for all content fragments and descriptive network events associated with a communications session, and
(b) non-intrusively capturing and copying all of said content fragments into a store of aggregated session content, and
(c) non-intrusively capturing and copying all of said descriptive network events into a session description record, and
(d) combining said session description record and said store of aggregated session content into a single session record to generate a session content record for said communications session, and
(e) configuring a privacy preference profile regarding proprietary content information and proprietary network information and who may access said content and network information, and
(f) generating a privacy preference detail record from said privacy preference profile, said privacy preference detail record containing the privacy preferences regarding access authorization to said content and network information, and
(g) further combining said privacy preference detail record and said session content record
whereby a single privacy-specified session content record is generated for said communications session.

4. The method of claim 3, wherein said communications session is an Internet Protocol-based communications session.
